(19) United States
(12) Patent Application Publication
(10) Pub. No.: US 2026/0105735 A1
(43) Pub. Date: Apr. 16, 2026

(54) Computing System with Multi-Layered and Unified Machine-Learning Model

(71) Applicant: Roku, Inc., San Jose, CA (US)

(72) Inventors: Frank Maker, Livermore, CA (US); Brian James Hetherman, Medford, MA (US)

(21) Appl. No.: 18/913,919

(22) Filed: Oct. 11, 2024

(51) Int. Cl. G06V 10/82; G06F 21/62; G06V 10/77; G06V 10/94; G06V 30/18; G06V 40/10

(52) U.S. Cl. CPC G06V 10/82; G06F 21/62; G06V 10/7715; G06V 10/945; G06V 30/18; G06V 40/10

(57) ABSTRACT

In one aspect, an example method is provided. The method includes receiving media content; providing the received media content to a first portion of layers of a trained machine-learning model, wherein the first portion of layers of the trained machine-learning model is configured to run within a trusted execution environment of a computing system; receiving, from the first portion of layers of the trained machine-learning model, extracted feature data of the provided media content; providing the extracted feature data to a second portion of layers of the machine-learning model, wherein the second portion of layers of the machine-learning model is configured to run outside the trusted execution environment of the computing system; receiving, from the second portion of layers of the machine-learning model, output data; and using the received output data to perform an action.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example method is provided. The method includes receiving media content; providing the received media content to a first portion of layers of a trained machine-learning model, wherein the first portion of layers of the trained machine-learning model is configured to run within a trusted execution environment of a computing system; receiving, from the first portion of layers of the trained machine-learning model, extracted feature data of the provided media content, wherein the extracted feature data was generated by the first portion of layers of the trained machine-learning model based at least in part on the provided media content; providing the extracted feature data to a second portion of layers of the machine-learning model, wherein the second portion of layers of the machine-learning model is configured to run outside the trusted execution environment of the computing system; receiving, from the second portion of layers of the machine-learning model, output data, wherein the output data was generated by the second portion of layers of the trained machine-learning model based at least in part on the provided extracted feature data; and using the received output data to perform an action.

In another aspect, an example computing system is provided. The computing system includes a processor and a non-transitory computer-readable medium having stored thereon program instructions that upon execution by the processor, cause performance of a set of acts comprising: receiving media content; providing the received media content to a first portion of layers of a trained machine-learning model, wherein the first portion of layers of the trained machine-learning model is configured to run within a trusted execution environment of the computing system; receiving, from the first portion of layers of the trained machine-learning model, extracted feature data of the provided media content, wherein the extracted feature data was generated by the first portion of layers of the trained machine-learning model based at least in part on the provided media content; providing the extracted feature data to a second portion of layers of the machine-learning model, wherein the second portion of layers of the machine-learning model is configured to run outside the trusted execution environment of the computing system; receiving, from the second portion of layers of the machine-learning model, output data, wherein the output data was generated by the second portion of layers of the trained machine-learning model based at least in part on the provided extracted feature data; and using the received output data to perform an action.

In another aspect, an example non-transitory computer-readable medium is provided. The non-transitory computer-readable medium has stored thereon program instructions that upon execution by a processor, cause performance of a set of operations including: receiving media content; providing the received media content to a first portion of layers of a trained machine-learning model, wherein the first portion of layers of the trained machine-learning model is configured to run within a trusted execution environment of a computing system; receiving, from the first portion of layers of the trained machine-learning model, extracted feature data of the provided media content, wherein the extracted feature data was generated by the first portion of layers of the trained machine-learning model based at least in part on the provided media content; providing the extracted feature data to a second portion of layers of the machine-learning model, wherein the second portion of layers of the machine-learning model is configured to run outside the trusted execution environment of the computing system; receiving, from the second portion of layers of the machine-learning model, output data, wherein the output data was generated by the second portion of layers of the trained machine-learning model based at least in part on the provided extracted feature data; and using the received output data to perform an action.

### BRIEF DESCRIPTION OF THE DRAWINGS

FIG. 1 illustrates a block diagram of an example computing system, in accordance with example embodiments.

FIG. 2 illustrates a block diagram of a machine-learning model operating partially within a trusted execution environment, in accordance with example embodiments.

FIG. 3 illustrates a process and data flow diagram, in accordance with example embodiments.

FIG. 4 illustrates a flow chart of an example method.

### DETAILED DESCRIPTION

### I. Overview

Media content often has content protection requirements. For example, a video portion of the media content may be required to be decoded only in a sandboxed area of execution within a computing system to help avoid piracy. For various reasons, it might be useful for a computing system to leverage machine-learning models to perform computer vision tasks on media content, but in some cases (e.g., where there is limited computing and memory resources available, especially within a sandboxed area of execution), it might not be practical or possible to have multiple computer vision machine-learning models run on each video frame of the media content.

To help address these and other limitations, disclosed herein are alternative techniques that can facilitate a computing system performing computer vision tasks on protected media content, by way of using a multi-layered and unified machine-learning model. As noted above, a video portion of media content may be required to be decoded only in a sandboxed area of execution within a computing system to help avoid piracy. However, by using a multi-layered machine learning model, feature extraction and computer vision tasks can be separated. In this context, “feature data” refers to representations of raw data (e.g. video content), which may then be used for machine learning tasks. While the video content itself may not be able to be transmitted outside of the sandboxed area of execution, feature data extracted from the video content may be able to. Feature data is often numerical and unintelligible to human observers, which can help reduce and/or eliminate the piracy risk associated with allowing extracted feature data to be transmitted outside of the sandboxed area of execution.

Additionally, in situations where there are limited computing and memory resources available within a sandboxed area of execution, the multi-layered model can allow for more scalable computer vision layers to make use of often more abundant resources outside of the sandboxed area of execution while retaining the feature extraction layers within the sandboxed area of execution. This can also have the benefit of providing a “common” feature extraction system, as the extracted features may then be provided to multiple computer vision layers (or even models), each performing different tasks, which may be referred to as “multi-task learning.” This can help reduce and/or avoid unnecessary duplication and can help limit the use of computing resources by running a full, separate model (feature extraction and computer vision) for each task.

More specifically, according to one example, a computing system can (i) receive media content; (ii) provide the received media content to a first portion of layers of a trained machine-learning model, wherein the first portion of layers of the trained machine-learning model is configured to run within a trusted execution environment of a computing system; (iii) receive, from the first portion of layers of the trained machine-learning model, extracted feature data of the provided media content, wherein the extracted feature data was generated by the first portion of layers of the trained machine-learning model based at least in part on the provided media content; (iv) provide the extracted feature data to a second portion of layers of the machine-learning model, wherein the second portion of layers of the machine-learning model is configured to run outside the trusted execution environment of the computing system; (v) receive, from the second portion of layers of the machine-learning model, output data, wherein the output data was generated by the second portion of layers of the trained machine-learning model based at least in part on the provided extracted feature data; and (vi) use the received output data to perform an action. These and related operations, systems, and features will now be described in greater detail.

### II. Example Architecture

### A. Computing System

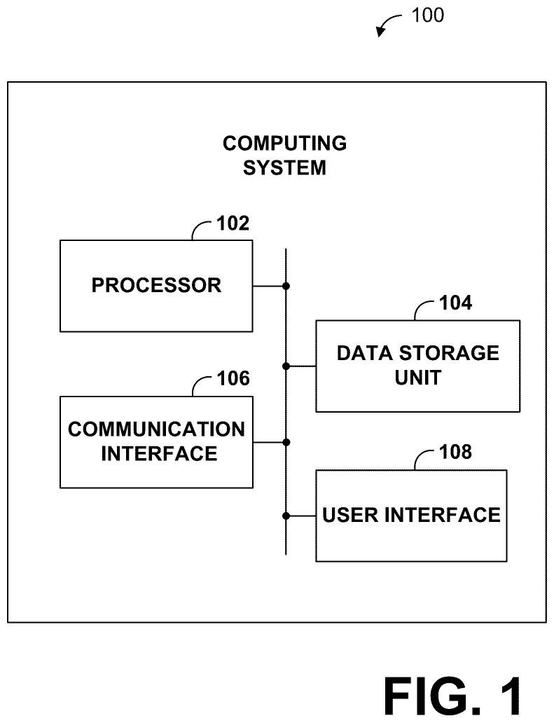

FIG. 1 is a simplified block diagram of an example computing system 100. The computing system 100 can be configured to perform and/or can perform one or more operations, such as the operations described in this disclosure. The computing system 100 can include various components, such as a processor 102, a data-storage unit 104, a communication interface 106, and/or a user interface 108.

The processor 102 can be or include a general-purpose processor (e.g., a microprocessor) and/or a special-purpose processor (e.g., a digital signal processor and/or an AI accelerator such as a neural processing unit (NPU)). The processor 102 can execute program instructions included in the data-storage unit 104 as described below.

The data-storage unit 104 can be or include one or more volatile, non-volatile, removable, and/or non-removable storage components, such as magnetic, optical, and/or flash storage, and/or can be integrated in whole or in part with the processor 102. Further, the data-storage unit 104 can be or include a non-transitory computer-readable storage medium, having stored thereon program instructions (e.g., compiled or non-compiled program logic and/or machine code) that, upon execution by the processor 102, cause the computing system 100 and/or another computing system, and/or another system to perform one or more operations, such as the operations described in this disclosure. These program instructions can define, and/or be part of, a discrete software application.

In some instances, the computing system 100 can execute program instructions in response to receiving an input, such as an input received via the communication interface 106 and/or the user interface 108. The data-storage unit 104 can also store other data, such as any of the data described in this disclosure.

The communication interface 106 can allow the computing system 100 to connect with and/or communicate with another entity according to one or more protocols. Therefore, the computing system 100 can transmit data to, and/or receive data from, one or more other entities according to one or more protocols. In one example, the communication interface 106 can be or include a wired interface, such as an Ethernet interface, a High-Definition Multimedia Interface (HDMI), or a Universal Serial Bus (USB) interface. In another example, the communication interface 106 can be or include a wireless interface, such as a cellular, Bluetooth, or Wi-Fi interface.

The user interface 108 can allow for interaction between the computing system 100 and a user of the computing system 100. As such, the user interface 108 can be or include an input component such as a keyboard, a mouse, a remote controller, a microphone, and/or a touch-sensitive panel. The user interface 108 can also be or include an output component such as a display device (which, for example, can be combined with a touch-sensitive panel) and/or a sound speaker.

The computing system 100 can also include one or more connection mechanisms that connect various components within the computing system 100. For example, the computing system 100 can include the connection mechanisms represented by lines that connect components of the computing system 100, as shown in FIG. 1.

The computing system 100 can include one or more of the above-described components and can be configured or arranged in various ways. For example, the computing system 100 can be configured as a server and/or a client (or perhaps a cluster of servers and/or a cluster of clients) operating in one or more server-client type arrangements, for instance.

In some cases, the computing system 100 can take the form of a more specific type of computing system, such as a desktop computer, a laptop, a tablet, a mobile phone, a television, a set-top box, a content streaming stick, a head-mountable display, or various combinations thereof, among other possibilities.

### B. Trusted Execution Environment

As noted above, the computing system 100 may include a processor 102. The processor 102 may include a trusted execution environment (TEE) , which may be a portion of the processor. The TEE may be a sandboxed area of execution that is configured to limit access to data inside the TEE.

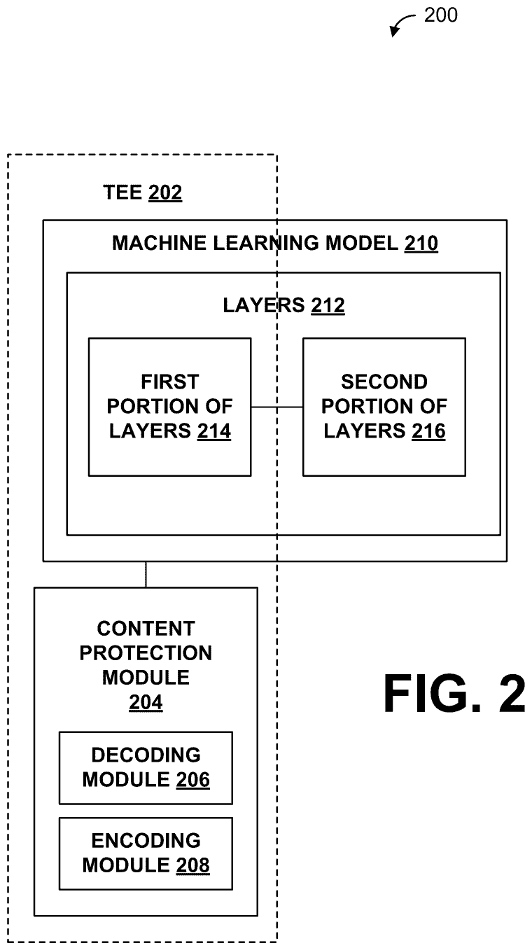

FIG. 2 illustrates a unified model 200 for machine learning with a TEE 202. The TEE 202 may include a content protection module 204, which itself may include a decoding module 206 and an encoding module 208. As noted above, protected media content can be required to be decoded only in a sandboxed area of execution (such as a TEE) within a computing system to avoid piracy. In this way, the TEE may be configured to prevent decoded content leaving the TEE without being re-encoded.

While a TEE can be a sandboxed portion of a processor, as described above, in some embodiments, the TEE may involve a wired network to which a computing system is connected. Thus, a device connected to such a “trusted” network may be permitted to encode and decode protected content without the need for a processor or system-specific TEE.

The unified model 200 can also include a machine-learning model 210. The machine-learning model may be trained, and may include a plurality of layers 212. The layers 212 may include a first portion of layers 214 and a second portion of layers 216. Either or both of the first portion of layers 214 and the second portion of layers 216 may include a neural network. Such a neural network may be a convolutional neural network, a deep neural network, a recurrent neural network, and/or any other type of neural network known now or later discovered.

The first portion of layers 214 may be configured to run within the TEE, while the second portion of layers 216 may be configured to run outside of the TEE, as illustrated in FIG. 2. This split functionality allows for the first portion of layers 214 to perform a first set of tasks (e.g. feature extraction) and for the second portion of layers 216 to perform a second set of tasks (e.g. computer vision tasks), without the need for the entire model to operate within the TEE. This can be beneficial, as a TEE may have access to limited computing resources as compared to the rest of a computing system.

Further details of the functioning of the unified model 200, and related operations and features, will be discussed below.

### III. Example Operations

The computing system 100, unified model 200, and/or components thereof can be configured to perform and/or can perform one or more operations. Various example operations that the computing system 100, the unified model 200, and/or components thereof, can perform, and related features, will now be described with reference to various figures.

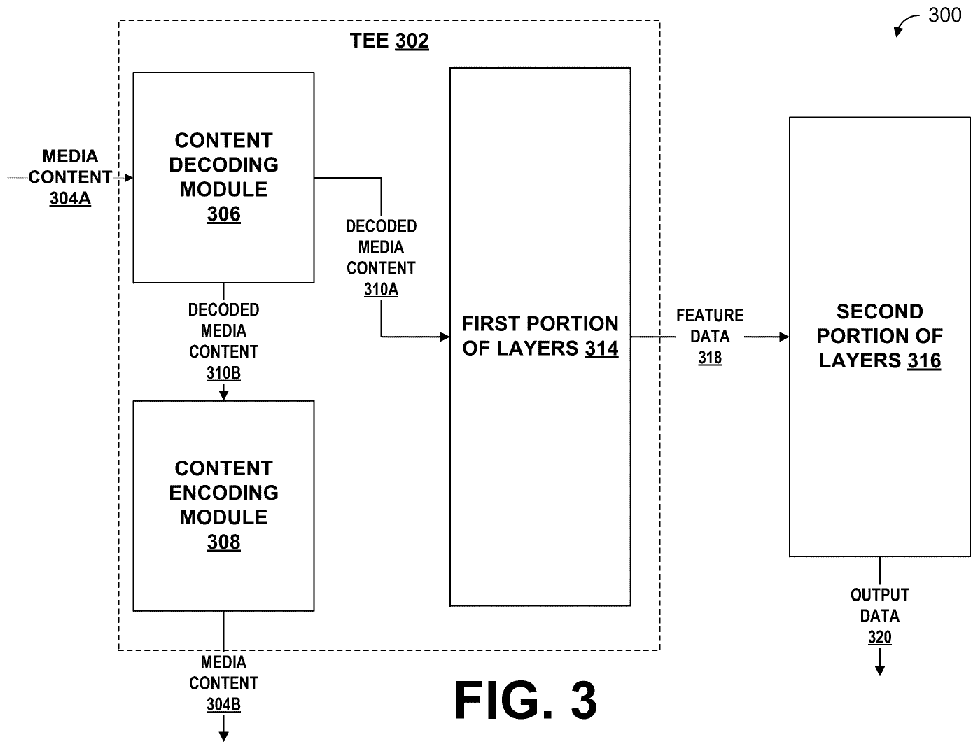

FIG. 3 illustrates an example process and data flow 300 involving components of the unified model 200.

To begin, the unified model 200 may receive media content 304A. Media content can be represented digitally by media data (e.g., image, video, and/or audio data), which can be generated, stored, and/or organized in various ways and according to various formats and/or protocols, using any related techniques now known or later discovered. Image and/or video data can also be stored and/or organized in various ways. For example, image and/or video data can be stored in various digital file formats, such as the Portable Network Graphics (PNG), JPG format, and the MPEG-4 format, among numerous other possibilities.

Media content 304A, as discussed above, may be protected using a copy-protection measure. Such a measure could involve encoding and/or encryption. One example of copy-protection is High-bandwidth Digital Content Protection (HDCP), which is often used when transmitting media content between devices, such as between a set-top box and a television.

Media content 304A, when received by the unified model 200, may be transmitted to a TEE 302, which may be the same as or similar to the TEE 202 of FIG. 2. The media content 304A, if protected, may then be decoded (and/or decrypted) by a content decoding module 306 within the TEE to produce decoded media content 310A/310B.

In some embodiments, the media content 304A may be intended to be transmitted to another device for display (e.g., a television or projector), and thus some copy-protection measures may require that the content be re-encoded or re-encrypted before being transmitted. In FIG. 3, this is accomplished by a content encoding module 308, which receives decoded media content 310B from the content decoding module, and respectively produces (re-encoded) media content 304B that may be transmitted for further display. Such a transmission, depending on the copy-protection measure, may be transmitted via a copy-protected link.

Decoded media content 310A may then be provided to a first portion of layers 314 of a trained machine-learning model. The first portion of layers 314, as depicted in FIG. 3, is configured to run within the TEE. Some copy-protection measures make use of a TEE to ensure that protected content does not leave the TEE or that outside programs cannot access data within the TEE in order to prevent piracy, and thus for this reason the first portion of layers 314 runs within the TEE.

In some embodiments, the first portion of layers may include a neural network. Such a neural network may be a convolutional neural network, a deep neural network, a recurrent neural network, and/or any other type of neural network known now or later discovered.

The first portion of layers 314 may generate extracted feature data 318 of the decoded media content 310A. In this context, “feature data” refers to representations of raw data, which may then be used for machine learning tasks. Feature data, while retaining information from the raw data, is permitted to leave the TEE, in contrast to the original decoded media content 310A. In some embodiments, the feature data may be generated by a vectorization process and/or a hashing process performed on the decoded media content 310A. In some embodiments, the extracted feature data may be configured to be unintelligible to a human observer (i.e. only readable by a machine).

In some situations, the extracted feature data may be used to reconstruct the original “raw data,” such as if an outside observer has access to or knowledge of the first portion of layers 314. For example, another model, configured to be an inverse of the first portion of layers 314, could be used to reconstruct the raw data. Thus, in some situations, for example those where an outside observer may have access to or knowledge of some combination of the first portion of layers 314, at least a portion of the raw data, and/or at least a portion of the extracted feature data, additional restrictions may be placed on access to the extracted feature data outside of the TEE. For example, only verified processes or devices may be permitted to access the extracted feature data even outside of the TEE in order to reduce the risk of reconstructing the raw data.

As shown in FIG. 3, the extracted feature data 318 may be provided to a second portion of layers 316, which is configured to run outside the TEE. As noted above, feature data is permitted to leave the TEE, and may be used for further machine learning tasks and responsively produce output data 320. The output data 320 may then be used as a basis to perform one or more actions. For instance, the second portion of layers 316 may be configured to perform one or more computer vision tasks. In some embodiments, the second portion of layers 316 may include a neural network. Such a neural network may be a convolutional neural network, a deep neural network, a recurrent neural network, and/or any other type of neural network known now or later discovered.

The second portion of layers 316, being outside the TEE, has the advantage of being further scalable and easier to update as it does not need to comply with the TEE's restrictions on data access (as described above).

In some embodiments, the second portion of layers 316 is configured to perform automatic content recognition (ACR) on the extracted feature data. In such a case, the output data 320 may include automatic content recognition data. In this context “automatic content recognition” refers to the identification of media content (or a portion thereof) by a computing system. Thus, rather than performing ACR on the decoded media content 310A and thus being limited to the TEE, ACR may be performed by the second portion of layers 316.

In some embodiments, the media content 304A may include video content, and a first subset of layers of the second portion of layers 316 may be configured to identify individuals within the video content based on the extracted feature data 318. In such a case, the output data 320 may then include identification data associated with the identified individuals within the video content. For example, the first subset of layers of the second portion of layers 316 may be configured to identify actors within video content by comparing identified faces to a database of actors that the first subset of layers of the second portion of layers 316 was trained on.

In some embodiments, a second subset of layers of the second portion of layers 316 may be configured to detect objects based on the extracted feature data. For instance, it may search for certain objects/items for analysis, such as a soda can, which may be used as a basis for later object insertion or other action.

In some embodiments, a third subset of layers of the second portion of layers may be configured to recognize text based on the extracted feature data. For instance, it may attempt to read signs in order to transcribe them for subtitling or closed-captioning purposes, for example.

The output data 320 can then be used to perform one or more actions. In some embodiments, the action may involve transmitting the output data 320 to a content-presentation device. In some embodiments, the content-presentation device may be a television or a set-top box.

One example benefit of performing such actions based upon the output data 320 is that, since the action can be based upon the extracted feature data 318, the action need not be performed later in the process or as a further post-processing step. This can decrease the latency between the reception of the media content and performing the action, and thus can speed up the operations of the entire system. As noted above, there can also be other benefits to a “common” feature extraction system, as the extracted features may then be provided to multiple computer vision layers (or even models), each performing different tasks. This can reduce and/or avoid unnecessary duplication and can limit the use of computing resources by running a full, separate model (feature extraction and computer vision) for each task.

As noted above, the output data 320 may also be used for a variety of purposes, including machine learning tasks. In some embodiments, the output data 320 may include objection detection data, and the action may involve performing object replacement within the media content. For instance, a machine-learning layer may be configured to detect soda cans, and this information may be used as a basis to replace the soda can with a different brand of soda, or even replacing the soda can with a different beverage type altogether, using post-processing methods.

In some embodiments, the output data 320 may include person identification data, and the action may involve generating an overlay comprising the person identification data and displaying the overlay upon the media content. For instance, a machine-learning layer may be configured to identify actors within video content by comparing identified faces to a database of actors that the layer was trained on. This identification data may then be used to generate an overlay identifying the actors within the media content, which may then be displayed upon the media content to inform viewers of the actors within a particular frame or scene of the media content.

In some embodiments, the output data 320 may include recognized text data, and the action may involve generating subtitles for the media content based upon the recognized text. For instance, a machine-learning layer may be configured to recognize text on signs or other text-based items within media content, and responsively generate subtitles for what text is upon the sign or text-based item. This may improve accessibility for vision-impaired viewers of the media content, as one example benefit.

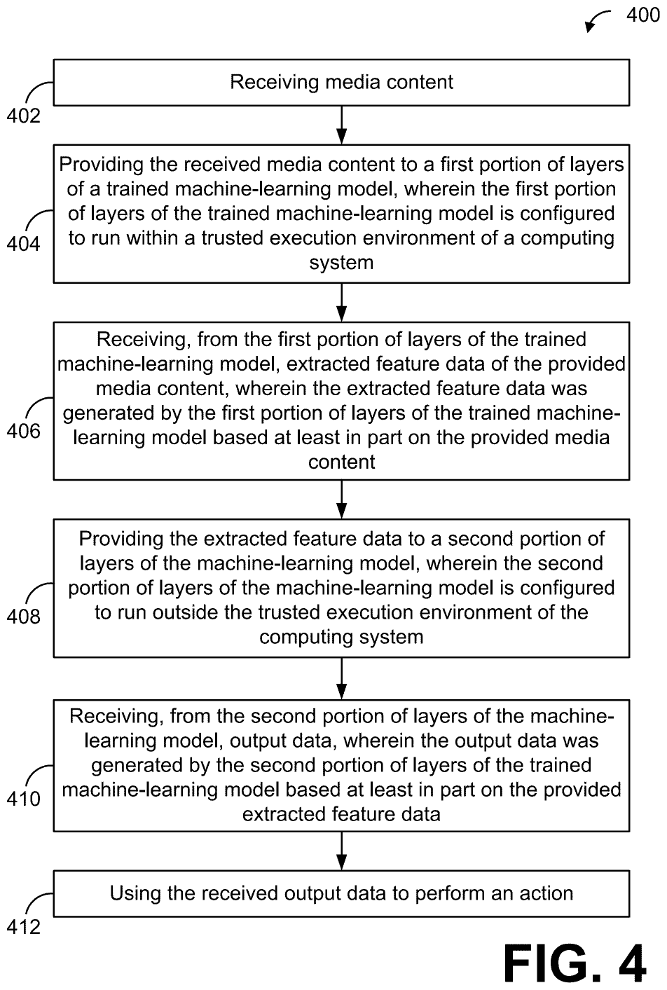

FIG. 4 is a flow chart illustrating an example method 400.

At block 402, the method 400 involves receiving media content.

At block 404, the method 400 involves providing the received media content to a first portion of layers of a trained machine-learning model, wherein the first portion of layers of the trained machine-learning model is configured to run within a trusted execution environment of a computing system.

At block 406, the method 400 involves receiving, from the first portion of layers of the trained machine-learning model, extracted feature data of the provided media content, wherein the extracted feature data was generated by the first portion of layers of the trained machine-learning model based at least in part on the provided media content.

At block 408, the method 400 involves providing the extracted feature data to a second portion of layers of the machine-learning model, wherein the second portion of layers of the machine-learning model is configured to run outside the trusted execution environment of the computing system.

At block 410, the method 400 involves receiving, from the second portion of layers of the machine-learning model, output data, wherein the output data was generated by the second portion of layers of the trained machine-learning model based at least in part on the provided extracted feature data.

At block 412, the method 400 involves using the received output data to perform an action.

In some embodiments, the media content is protected using a copy-protection measure.

In some embodiments, the first portion of layers of the trained machine-learning model comprises a neural network.

In some embodiments, the neural network comprises a convolutional neural network.

In some embodiments, the trusted execution environment of the computing system comprises a portion of a processor of the computing system, wherein the trusted execution environment is configured to limit access to data inside the trusted execution environment.

In some embodiments, the trusted execution environment of the computing system comprises a wired network to which the computing system is connected.

In some embodiments, generating the extracted feature data comprises at least one of a vectorization process or a hashing process.

In some embodiments, the extracted feature data is configured to be unintelligible to a human observer.

In some embodiments, the second portion of layers is configured to perform automatic content recognition on the extracted feature data, wherein the output data comprises automatic content recognition data.

In some embodiments, the media content comprises video content, and wherein a first subset of layers of the second portion of layers is configured to identify individuals within the video content based on the extracted feature data.

In some embodiments, the output data comprises identification data associated with the identified individuals within the video content.

In some embodiments, a second subset of layers of the second portion of layers is configured to detect objects based on the extracted feature data.

In some embodiments, a third subset of layers of the second portion of layers is configured to recognize text based on the extracted feature data.

In some embodiments, method 400 further includes transmitting, via a copy-protected link, the media content to a device linked to the computing system.

In some embodiments, method 400 further includes updating, by the computing system, the second portion of layers of the machine-learning model, wherein during the updating, the first portion of layers remain unmodified.

In some embodiments, the action comprises transmitting the received output data to a content-presentation device.

In some embodiments, the content-presentation device comprises a television.

In some embodiments, the content-presentation device comprises a set-top box.

In some embodiments, the output data comprises person identification data, and wherein the action comprises generating an overlay comprising the person identification data and displaying the overlay upon the media content.

In some embodiments, the output data comprises object recognition data, and wherein the action comprises inserting an object into the media content based upon the object recognition data.

In some embodiments, the operations of method 400 may be performed by a computing system. In some embodiments, the operations of method 400 may be caused by execution by a processor of program instructions stored on a non-transitory computer-readable medium.

### IV. Example Variations

Although some of the acts and/or functions described in this disclosure have been described as being performed by a particular entity, the acts and/or functions can be performed by any entity, such as those entities described in this disclosure. For example, some or all operations can be performed sever-side and/or client-side. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

What is claimed is:

1. A method comprising:
receiving media content;
providing the received media content to a first portion of layers of a trained machine-learning model, wherein the first portion of layers of the trained machine-learning model is configured to run within a trusted execution environment of a computing system;
receiving, from the first portion of layers of the trained machine-learning model, extracted feature data of the provided media content, wherein the extracted feature data was generated by the first portion of layers of the trained machine-learning model based at least in part on the provided media content;
providing the extracted feature data to a second portion of layers of the machine-learning model, wherein the second portion of layers of the machine-learning model is configured to run outside the trusted execution environment of the computing system;
receiving, from the second portion of layers of the machine-learning model, output data, wherein the output data was generated by the second portion of layers of the trained machine-learning model based at least in part on the provided extracted feature data; and
using the received output data to perform an action.

2. The method of claim 1, wherein the media content is protected using a copy-protection measure.

3. The method of claim 1, wherein the first portion of layers of the trained machine-learning model comprises a neural network.

4. The method of claim 3, wherein the neural network comprises a convolutional neural network.

5. The method of claim 1, wherein the trusted execution environment of the computing system comprises a portion of a processor of the computing system, and wherein the trusted execution environment is configured to limit access to data inside the trusted execution environment.

6. The method of claim 1, wherein the trusted execution environment of the computing system comprises a wired network to which the computing system is connected.

7. The method of claim 1, wherein generating the extracted feature data comprises at least one of a vectorization process or a hashing process.

8. The method of claim 1, wherein the extracted feature data is configured to be unintelligible to a human observer.

9. The method of claim 1, wherein the second portion of layers is configured to perform automatic content recognition on the extracted feature data, and wherein the output data comprises automatic content recognition data.

10. The method of claim 1, wherein the media content comprises video content, and wherein a first subset of layers of the second portion of layers is configured to identify individuals within the video content based on the extracted feature data.

11. The method of claim 10, wherein the output data comprises identification data associated with the identified individuals within the video content.

12. The method of claim 10, wherein a second subset of layers of the second portion of layers is configured to detect objects based on the extracted feature data.

13. The method of claim 12, wherein a third subset of layers of the second portion of layers is configured to recognize text based on the extracted feature data.

14. The method of claim 1, further comprising:
transmitting, via a copy-protected link, the media content to a device linked to the computing system.

15. The method of claim 1, further comprising:
updating, by the computing system, the second portion of layers of the machine-learning model, wherein during the updating, the first portion of layers remain unmodified.

16. The method of claim 1, wherein the action comprises transmitting the received output data to a content-presentation device.

17. The method of claim 1, wherein the output data comprises person identification data, and wherein the action comprises generating an overlay comprising the person identification data and displaying the overlay upon the media content.

18. The method of claim 1, wherein the output data comprises object recognition data, and wherein the action comprises inserting an object into the media content based upon the object recognition data.

19. A computing system comprising a processor and a non-transitory computer-readable medium having stored thereon program instructions that upon execution by the processor, cause performance of a set of acts comprising:
receiving media content;
providing the received media content to a first portion of layers of a trained machine-learning model, wherein the first portion of layers of the trained machine-learning model is configured to run within a trusted execution environment of the computing system;
receiving, from the first portion of layers of the trained machine-learning model, extracted feature data of the provided media content, wherein the extracted feature data was generated by the first portion of layers of the trained machine-learning model based at least in part on the provided media content;
providing the extracted feature data to a second portion of layers of the machine-learning model, wherein the second portion of layers of the machine-learning model is configured to run outside the trusted execution environment of the computing system;
receiving, from the second portion of layers of the machine-learning model, output data, wherein the output data was generated by the second portion of layers of the trained machine-learning model based at least in part on the provided extracted feature data; and
using the received output data to perform an action.

20. A non-transitory computer-readable medium containing thereon program instructions that when executed by a processor cause performance of operations comprising:
receiving media content;
providing the received media content to a first portion of layers of a trained machine-learning model, wherein the first portion of layers of the trained machine-learning model is configured to run within a trusted execution environment of a computing system;
receiving, from the first portion of layers of the trained machine-learning model, extracted feature data of the provided media content, wherein the extracted feature data was generated by the first portion of layers of the trained machine-learning model based at least in part on the provided media content;
providing the extracted feature data to a second portion of layers of the machine-learning model, wherein the second portion of layers of the machine-learning model is configured to run outside the trusted execution environment of the computing system;
receiving, from the second portion of layers of the machine-learning model, output data, wherein the output data was generated by the second portion of layers of the trained machine-learning model based at least in part on the provided extracted feature data; and
using the received output data to perform an action.
